(19) United States
(12) Patent Application Publication
(10) Pub. No.: US 2016/0333578 A1
(43) Pub. Date: Nov. 17, 2016

(54) DIVIDERS FOR DEFINING AND ILLUMINATING WORKSPACES

(71) Applicant: QUARKSTAR LLC, Las Vegas, NV (US)

(72) Inventors: Andrew Tien-Man Ng, Vancouver (CA); Wilson Dau, Calgary (CA)

(21) Appl. No.: 15/113,007

(22) PCT Filed: Jan. 29, 2015
(86) PCT No.: PCT/US2015/013597

§ 371 Date: Jul. 20, 2016

Related U.S. Application Data
(60) Provisional application No. 61/935,713, filed on Feb. 4, 2014.

(51) Int. Cl. E04B 2/74; F21V 11/16; F21V 33/00

(52) U.S. Cl. CPC E04B 2/74; E04B 2/7425; F21V 33/006; F21V 11/16; E04B 2002/7418; E04B 2002/7488; F21W 2131/402

(57) ABSTRACT

A workspace divider includes a divider frame, a screen secured to the divider frame so as to extend across and essentially span a central opening defined through the divider frame, and an illumination device carried by a top edge portion of the divider frame, the illumination device including a light source configured to emit light and disposed along the top edge portion of the divider frame, and a light transmitter extending from the top edge portion of the divider frame and configured to transmit light emitted from the light source and to direct the transmitted light laterally beyond at least one broad side of the divider frame, to illuminate a workspace bounded by the divider frame.

### TECHNICAL FIELD

The present disclosure relates to dividers for defining and illuminating workspaces.

### BACKGROUND

Various building spaces may need to be sectioned within existing dividers (e.g., walls) for providing desired spaces of a dedicated purpose (e.g., workspaces). In some cases, deployable room dividers may be used to define desired spaces within existing environments when room dividers are not present or otherwise do not adequately define such a space. Such deployable room dividers may be cumbersome to transport, require additional components to provide stabilization, or may be limited in size (e.g., length or height) for defining a desired space. Often, illumination for adequate visibility while performing tasks (e.g., work or meeting tasks) within the spaces requires additional lamps or other lighting.

### SUMMARY

In one aspect, a workspace divider includes a divider frame including a top edge portion, a bottom edge portion, and two side edge portions connecting the top and bottom edge portions and forming a lateral extent of two opposite broad sides of the divider frame. The workspace divider further includes a screen secured to the divider frame so as to extend across and essentially span a central opening defined through the divider frame between the top, bottom, and side edge portions. The workspace divider further includes an illumination device carried by the top edge portion of the divider frame, the illumination device including a light source configured to emit light and disposed along the top edge portion of the divider frame. The illumination device further includes a light transmitter extending from the top edge portion of the divider frame and configured to transmit light emitted from the light source and to direct the transmitted light laterally beyond at least one of the broad sides of the divider frame, to illuminate a workspace bounded by the divider frame.

In another aspect, a workspace divider system includes, in combination, two or more of the workspace dividers, arranged to cooperate to at least partially bound a workspace, with adjacent ones of the workspace dividers positioned with respective side edge portions proximate one another.

In another aspect, a workspace divider system includes a first divider and a second divider. The first divider includes a first divider frame including a top edge portion, a bottom edge portion, and two side edge portions connecting the top and bottom edge portions and forming a lateral extent of two opposite broad sides of the first divider frame. The first divider frame further includes a first screen secured to the first divider frame so as to extend across and essentially span a central opening defined through the first divider frame between the top, bottom, and side edge portions. The first divider frame further includes a first illumination device carried by the top edge portion of the first divider frame, the first illumination device including a light source configured to direct light laterally beyond at least one of the broad sides of the first divider frame, and a first electrical cable connected to the first illumination device.

The second divider includes a second divider frame including a top edge portion, a bottom edge portion, and two side edge portions connecting the top and bottom edge portions and forming a lateral extent of two opposite broad sides of the second divider frame. The second divider further includes a screen secured to the second divider frame so as to extend across and essentially span a central opening defined through the divider frame between the top, bottom, and side edge portions. The second divider further includes a second illumination device carried by the top edge portion of the second divider frame, the second illumination device including a light source configured to direct light laterally beyond at least one of the broad sides of the second divider frame, and a second electrical cable connected to the second illumination device. The first and second dividers include an electrical interconnection system by which the first and second electrical cables are electrically connectable to each other for mutual powering of the first and second illumination devices with the first and second dividers placed adjacent one another to bound a workspace.

Embodiments can include one or more of the following features alone or in combination.

In some embodiments, the workspace divider is free-standing.

In certain embodiments, the divider frame is adjustable in height.

In some embodiments, the two side edge portions each include an inner edge portion slidably disposed within an outer edge portion, such that the two side edge portions include a telescoping joint enabling height adjustment of the divider frame. In certain embodiments, the screen is adjustable in deployed length.

In some embodiments, the screen is stretchable.

In certain embodiments, the screen is opaque.

In some embodiments, the screen is translucent.

In certain embodiments, the screen is secured to the top edge portion of the divider frame.

In some embodiments, the illumination device is configured to direct light in an angular range towards the workspace and further includes a primary optical element configured to redirect the light emitted by the light source in a collimated angular range, and the transmitter of the illumination device is provided as a secondary optical element including a redirecting surface and an output surface, the redirecting surface arranged and configured to reflect the light received from the primary optical element in the collimated angular range, and the output surface arranged and configured to transmit the light reflected from the redirecting surface towards the workspace.

In certain embodiments, the illumination device further includes a light guide disposed between the primary optical element and the secondary optical element, the light guide configured to receive the light redirected by the primary optical element at a first end of the light guide and guide at least some of the light to the secondary optical element at a second end of the light guide.

In some embodiments, the illumination device is configured to direct the transmitted light at different angles or in different distributions beyond one or both of the two opposite broad sides of the divider frame.

In certain embodiments, the divider frame further includes ventilation holes that allow air to cool the illumination device via natural convection.

In some embodiments, the workspace divider further includes multiple support members disposed along the bottom edge portion of the divider frame.

In certain embodiments, the multiple support members are attached to the bottom edge portion of the divider frame and are pivotable between a collapsed/stowed and an extended configuration to extend laterally from the divider frame.

In some embodiments, the bottom edge portion defines recesses positioned and configured to receive the multiple support members with the multiple support members pivoted toward the frame in the collapsed/stowed configuration.

In certain embodiments, the workspace divider system further includes one or more mechanical connection members that can rigidly connect two or more workspace dividers.

In some embodiments, the workspace divider system further includes two or more electrical cables that are electrically connectable to each other for mutually powering the illumination devices of two or more workspace dividers.

Embodiments can include one or more of the following advantages.

In some embodiments, the workspace divider provides adequate ambient light within a space at least partially defined and/or bounded by the workspace divider or a divider system including the workspace divider. Such a space may be used for performing a variety of tasks or holding meetings among groups of individuals. The workspace divider can be free-standing and may be used for defining spaces when building or other room dividers (e.g., walls) are not present or otherwise do not adequately define a desired space. The workspace divider may be used as a stand-alone object, used with existing walls, used as multiple objects connected or spaced apart in series, or used as multiple objects in series with existing walls. In this manner, the workspace divider can allow a user to define or redefine a desired space on demand.

In certain embodiments, the support members of the workspace divider prevent the divider frame of the workspace divider from tipping over when excessive lateral forces are applied to the divider frame.

In some embodiments, the illumination device is positioned and configured to direct light laterally beyond one or both of the opposite broad sides of the workspace divider to illuminate the workspace defined by the workspace divider, or an area surrounding the workspace. The illumination device can provide ambient illumination with low glare and high efficiency light.

In certain embodiments, the mechanical interconnection system allows adjacent divider frames to interface with one another in a rigid manner and enable highly stable interconnections of workspace dividers.

In some embodiments, the electrical interconnection system allows power to be delivered to a set of cable harnesses within a single divider frame and then delivered to adjacent sets of cable harnesses within adjacent divider frames to power the illumination devices of the workspace dividers.

In certain embodiments, the workspace divider may be used to define and illuminate spaces other than workspaces, such as play areas and storage areas.

Other aspects, features, and advantages will be apparent from the description, the drawings, and the claims.

### DESCRIPTION OF DRAWINGS

FIG. 1 is a perspective view of a divider for defining and illuminating a workspace.

FIG. 2 is a perspective view of a lower portion of the divider of FIG. 1, illustrating a cable harness extending through a frame of the divider.

FIGS. 3A and 3B are perspective views of a lower portion of the divider of FIG. 1, illustrating support members of the divider oriented in extended and collapsed positions, respectively.

FIG. 4 is a perspective view of an upper portion of the divider of FIG. 1, illustrating an enlarged view of an illumination device of the divider.

FIG. 5 is a cross-sectional schematic view of the illumination device of FIG. 3.

FIG. 6 is a perspective view of a divider in a vertically extended configuration.

FIG. 7 is a perspective view of a lower portion of the divider of FIG. 6, illustrating a cable harness extending through a frame of the divider.

FIG. 8 is a perspective view of the lower portion of the divider of FIG. 6, illustrating a spring-loaded mechanism disposed within the frame of the divider.

FIG. 9 is a perspective view a divider system including the divider of FIG. 1 and the divider of FIG. 6.

FIG. 10 is a perspective view of a divider system including multiple dividers of FIG. 1.

FIG. 11 is a perspective view of a lower portion of the divider system of FIG. 10, illustrating interconnection between two adjacent dividers positioned in a linear configuration.

FIG. 12 is a perspective view of a divider system including multiple dividers of FIG. 6.

Like reference numbers and designations in the various drawings indicate like elements.

### DETAILED DESCRIPTION

The present disclosure describes dividers that provide adequate ambient light within a space at least partially defined and/or bounded by the divider or a divider system including the divider. Such a space may be used for performing a variety of tasks or holding meetings among groups of individuals. The dividers can be free-standing and may be used for defining spaces when building or other room dividers (e.g., walls) are not present or otherwise do not adequately define a desired space. The dividers may be used as stand-alone objects, used with existing walls, used as multiple objects connected or spaced apart in series, or used as multiple objects in series with existing walls. In this manner, the dividers of the present disclosure allow a user to define or redefine a desired space on demand.

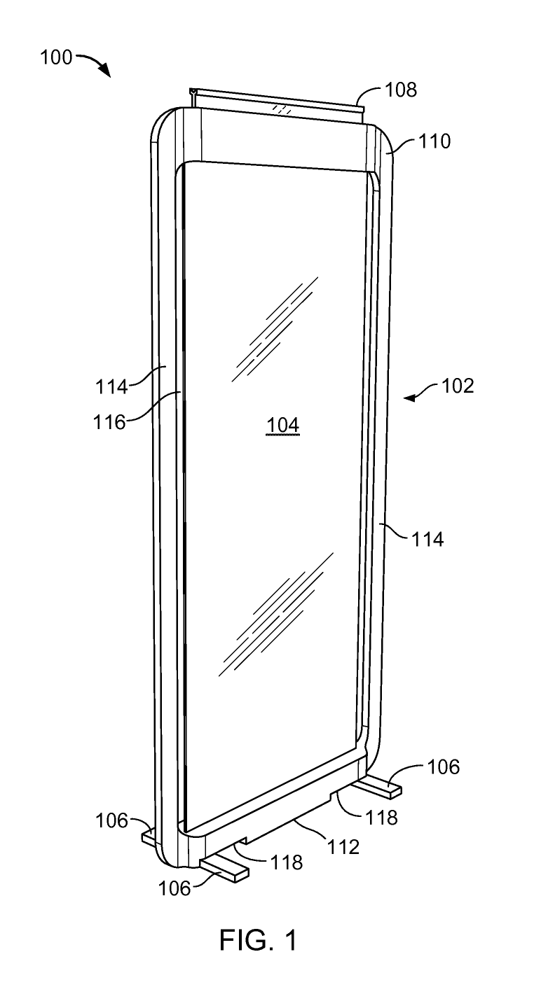

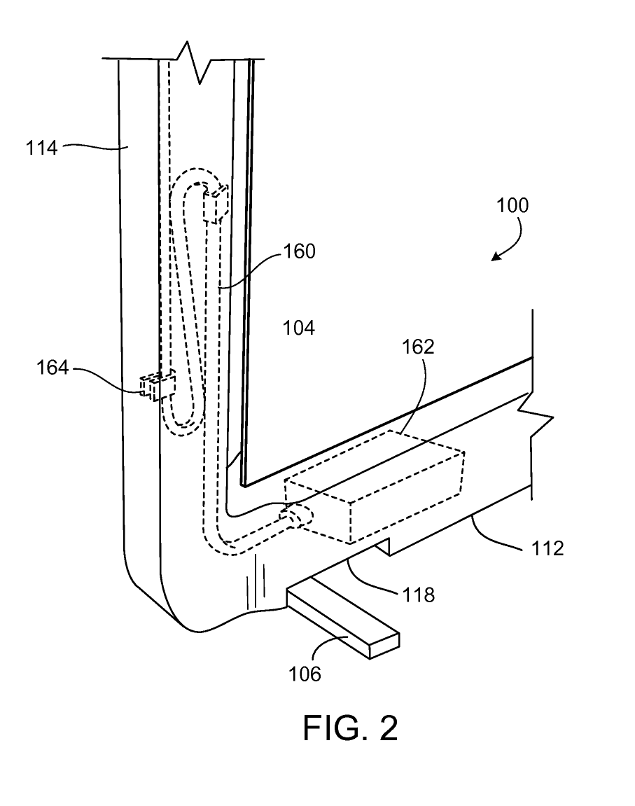

FIG. 1 illustrates a divider 100 that can be used to define (e.g., bound) and illuminate a workspace within an environment. Example environments within which the divider 100 may be deployed include offices, classrooms, homes, stores, warehouses, other building environments, and outdoor environments. The divider 100 includes a frame 102 and a screen 104 that is secured to the frame 102. The divider 100 further includes four support members 106 that extend from the frame 102, an illumination device 108 carried by the frame 102, and one or more cable harnesses (shown in FIG. 2) that extend through the frame 102. The illumination device 108 illustrated in FIG. 1 is a particular example illumination device. Other embodiments may include different illumination devices.

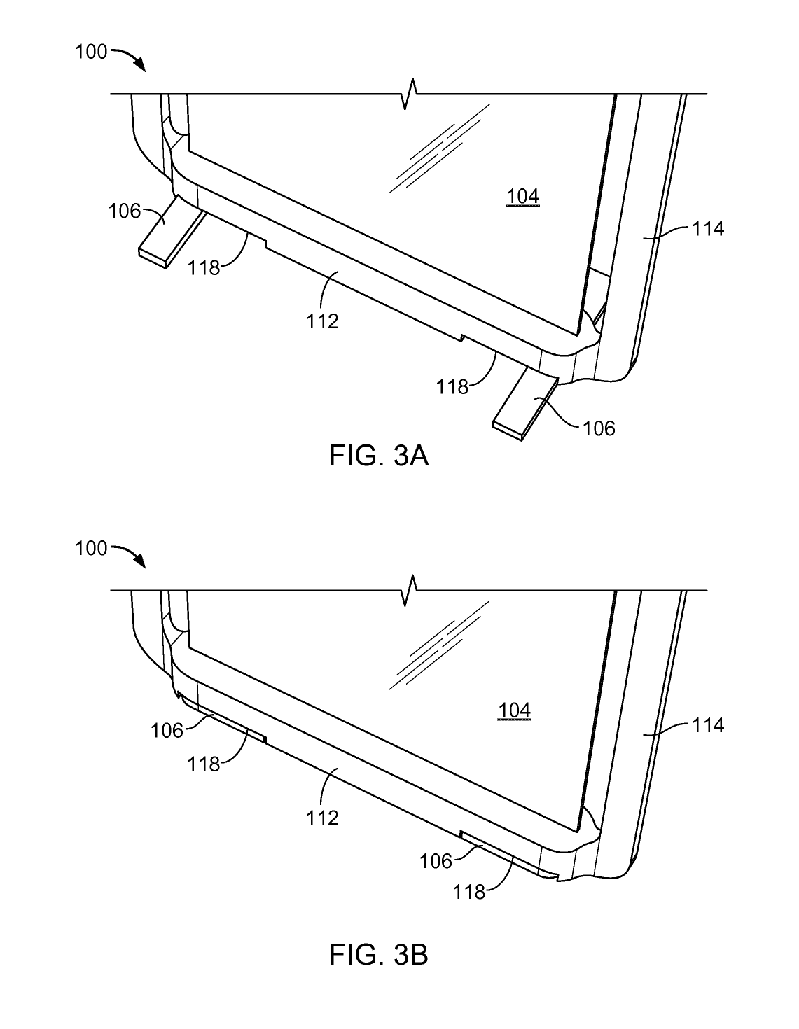

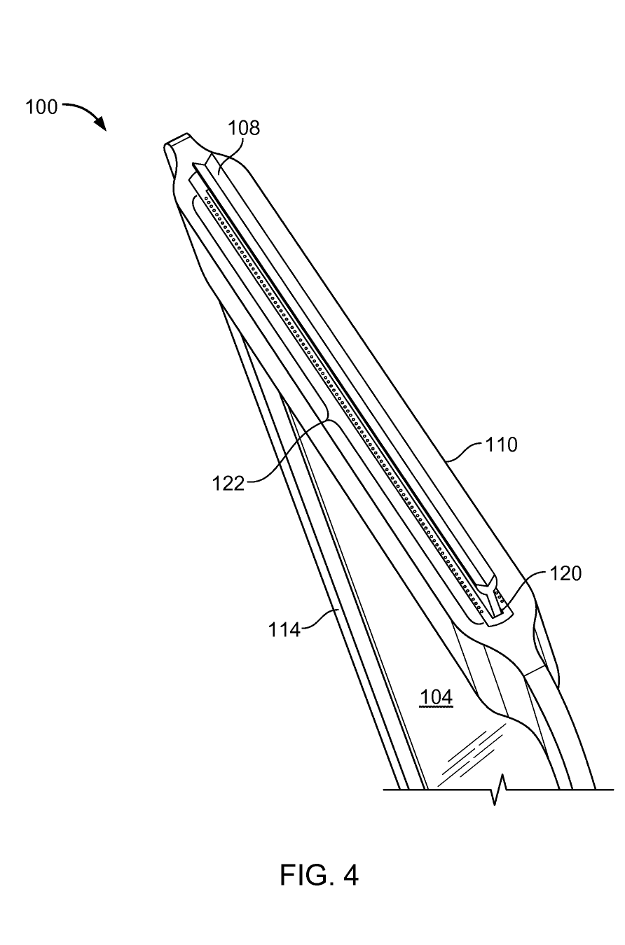

The frame 102 of the divider 100 is formed as a rigid, free-standing frame that includes a top edge member 110, a bottom edge member 112, and two side edge members 114 that together define a central opening 116 through the frame 102. The edge members 110, 112, 114 define interior channels through which the cable harnesses extend for providing power to the illumination device 108, as will be discussed in more detail with respect to FIG. 2 below. The cable harnesses within the frame 102 receive power (e.g., alternating current (AC) power) from a grounded electrical cable. The top edge member 110 of the frame 102 further defines a surface channel 120 (shown in FIG. 4) that is formed to carry the illumination device 108, as will be discussed in more detail below. The bottom edge member 112 of the frame 102 further defines two recesses 118 that are sized and shaped to accommodate the support members 106, as will be discussed in more detail with respect to FIGS. 3A and 3B.

The edge members 110, 112, 114 may be made of one or more materials that provide rigidity to the frame 102, such as aluminum or polycarbonate, for example. Example processes that may be used to manufacture the edge members 110, 112, 114 include metal stamping, casting, and extrusion. The edge members 110, 112, 114 may be assembled to form the frame 102 using fastener hardware via welding processes or other assembly elements. The frame 102 has a width (as measured between outer lateral edges of the opposing side edge members 114) of about 80 cm. The frame 102 has a height (as measured between the upper edge of the top edge member 110 and the lower edge of the bottom edge member 112) of about 170 cm. The frame 102 has an overall thickness (measured as a maximum thickness of the bottom edge member 112) of about 9 cm. The recesses 118 of the bottom edge member 112 have a length of about 15 cm. The frame 102 weighs about 20 kg. In a general embodiment, a divider for defining and illuminating a workspace may include a frame that has dimensions and/or material compositions different from those of the frame 102.

FIG. 2 illustrates a lower portion of the divider 100 with a cable harness 160 extending through the frame 102. The cable harness 160 is plugged into a power supply unit 162 disposed within the bottom edge member 112 and extends upward through the side edge member 114 to the illumination device 108. The cable harness 160 is coiled within the side edge member 114 and secured to internal surfaces of the side edge member 114 via brackets 164. In some embodiments, a cable harness 160 may extend alternatively or additionally through the opposing side of the frame 102.

Referring again to FIG. 1, the screen 104 of the divider 100 is formed as a web of material (e.g., a thin, flexible sheet of material) that provides a barrier between a defined workspace and a surrounding environment in which the divider 100 is located. The screen 104 substantially spans the central opening 116 of the frame 102. In the example of FIG. 1, the screen 104 is secured to the top and bottom edge members 110, 112 of the frame 102. However, in a general embodiment, a divider for defining and illuminating a workspace may include a screen that is secured to any combination of top, bottom, and side edge members of a divider frame to span a portion or substantially all of a frame central opening. In some cases, the screen 104 may be secured to a single edge member (e.g., the top edge member 110) of the frame 102 and rolled up such that the screen 104 spans only a portion (e.g., less than substantially all) of the central opening 116. In some embodiments, the screen extends sideways into slits inside guide rails or other elements of one or both of the side edge members.

The screen 104 aids in providing privacy within the defined workspace and in suppressing visual distractions that may appear outside of the defined workspace. For example, the screen 104 may be an opaque screen (e.g., preventing any or substantially any light from passing through the screen 104). In other cases, the screen 104 may be a translucent screen (e.g., allowing at least a portion of light impinging on the screen 104 to pass through the screen 104). The screen 104 may be made of one or more of an elastic material, an elastic woven material, a non-elastic material, and a non-elastic woven material. For example, elastic woven materials from which the screen 104 may be made include spandex fabrics (e.g., Lycra-content fabrics). Example processes that may be used to manufacture the screen 104 include weaving, extrusion, and casting. The screen 104 may be secured to any of the edge members 110, 112, 114 via various attachment mechanisms, such as adhesives and fastener hardware.

FIGS. 3A and 3B illustrate a lower portion of the divider 100 with the support members 106 shown in extended and collapsed positions, respectively. The support members 106 of the divider 100 are formed as pivotable foot extensions that extend from outer lateral edges of the bottom edge member 112 and that can support the frame 102. Referring particularly to FIG. 3A, in the extended position, the support members 106 help to prevent the frame 102 from tipping over in the event that excessive lateral forces are applied to the frame 102. For example, the frame 102 may be tilted about 3° to about 7° (e.g., about 5°) with respect to a central plane of the frame 102 (e.g., a plane oriented parallel to the screen 104) without tipping over when the support members 106 are collapsed within the recesses 118 of the bottom edge member 112 (as shown in FIG. 3B). In contrast, the frame 102 may be tilted about 12° to about 16° (e.g., about 14°) with respect to the central plane of the frame 102 without tipping over when the support members 106 are extended from the bottom edge member 112. The support members 106 have a length of about 15 cm. Accordingly, in the extended position (as shown in FIG. 3A), adjacent support members 106 extending in opposite directions span a total length of about 30 cm. Referring particularly to FIG. 3B, one or more of the support members 106 may be collapsed within respective recesses 118 of the bottom edge member 112 for shipping the divider 100 or for positioning the divider 100 adjacent or flat against a wall or any other surface. Some embodiments of the divider may have no support members or be configured to operate with separate modular support members that can be mated with the respective divider.

The support members 106 may be made of one or more materials that are sufficiently strong to support or withstand the weight of the frame 102, such as steel, compound or other materials. Example processes that may be used to manufacture the support members 106 include welding, forging, casting, machining and so forth. The support members 106 may be secured to the frame 102 via mechanical fastener hardware or other components. In a general embodiment, a divider for defining and illuminating a workspace may include support members that have dimensions and/or material compositions different from those of the support members 106. In some cases, a divider for defining and illuminating a workspace may include more than four or less than four support members 106.

FIG. 4 illustrates an upper portion of the divider 100, showing the top of the frame 102 and the illumination device 108. The illumination device 108 is positioned and configured to direct light laterally beyond opposite sides of the divider 100 to illuminate a workspace defined by the divider 100, as well as an area surrounding the workspace. In some embodiments, the illumination device 108 may be configured as any of the luminaire modules described in PCT Patent Application No. PCT/US2013/059489, which is incorporated herein by reference in its entirety. The top edge member 110 of the frame 102 includes a surface channel 120 sized to carry the illumination device 108. The top edge member 110 also defines a series of vent holes 122 positioned along the surface channel 120 that allow passage of air to cool the illumination device 108 via natural convection. Additional vent holes may be positioned in the bottom edge member 112 and/or the side edge members 114 to form a flue with corresponding edge members.

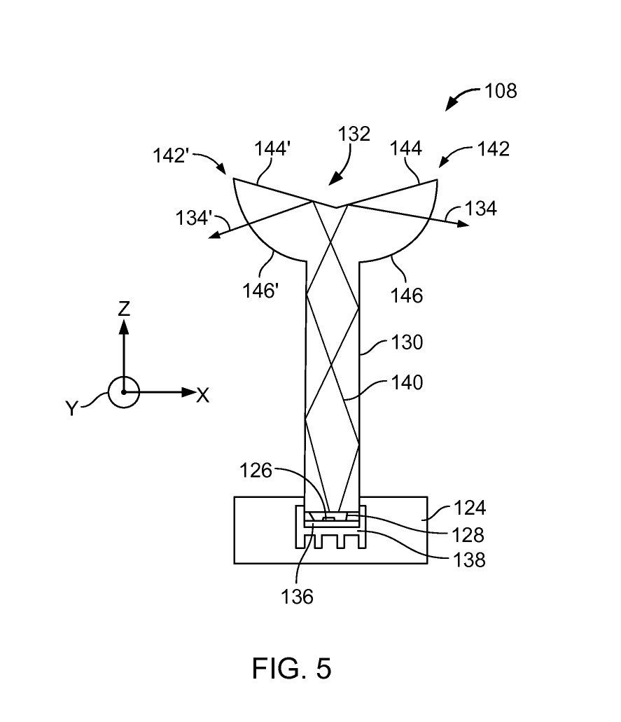

FIG. 5 illustrates a cross-sectional schematic view of an example illumination device 108 of the divider 100. The illumination device 108 includes a mount 124, multiple light sources 126 (e.g., light-emitting diodes (LEDs) or other artificial light-emitting elements) disposed along a length of the mount 124, primary optical elements 128 (e.g., optical couplers) corresponding to respective light sources 126, a light guide 130 extending from the mount 124, and a secondary optical element 132 (e.g., an optical extractor) extending from the light guide 130. A Cartesian coordinate system is shown for schematic reference. In the example of FIG. 5, the coordinate system is oriented relative to the illumination device 108 such that the illumination device 108 is elongated along a y-axis (extending out of the plane of FIG. 5), and light output by the illumination device 108 in first and second angular ranges 134, 134′ has a prevalent propagation direction with a non-zero component that is antiparallel to the z-axis.

The mount 124 extends along the length of the illumination device 108 and supports a substrate 136 that further supports the light sources 126 and the primary optical elements 128. The mount 124 further supports a heat sink 138 that receives heat radiated from the light sources 126. The light sources 126 are powered by the cable harnesses extending through the edge members 110, 112, 114. Light is emitted from the light sources 126, transmitted by the primary optical elements 128 to the light guide 130, and further guided by the light guide 130 in a collimated angular range 140 to the secondary optical element 132.

The secondary optical element 132 includes two opposing portions 142, 142′ that provide a symmetric structure and accordingly symmetric light emission from the illumination device 108. The opposing portions 142, 142′ respectively include redirecting surfaces 144, 144′ and output surfaces 146, 146′. The redirecting surfaces 144, 144′ respectively transmit light from the light guide 130 to the output surfaces 146, 146′. The light is transmitted respectively through the output surfaces 146, 146′ within the angular ranges 134, 134′ to provide symmetric light emission from the illumination device 108 (i.e., to direct light beyond each side of the frame 102 at substantially equal distributions and angles with respect to the central plane of the frame 102). Accordingly, the illumination device 108 provides ambient illumination to a workspace defined adjacent a first side of the divider 100, as well as an area adjacent a second, opposite side of the divider 100. The illumination device 108 can provide the ambient illumination with low glare and high efficiency light.

In some cases, the illumination device 108 may include 48 or another number of light sources 126. The illumination device 108 has a length (extending along the y-axis) of about 60 cm and a height (extending in the z-axis) of about 20 cm. In the example of FIG. 5, both redirecting surfaces 144, 144′ are planar, and both output surfaces 146, 146′ are concave in shape. However, in some instances, a divider for defining and illuminating a workspace may include an illumination device that has redirecting surfaces and output surfaces that have any combination of planar, concave, or convex shapes. In a general embodiment, a divider for defining and illuminating a workspace may include an illumination device that has primary and secondary optical elements of various geometries that are specifically tailored to achieve desired orientations and divergences of angular ranges of output surfaces of the secondary optical elements. In some cases, the illumination device 108 may include a panel enclosure (not shown) that surrounds one or more of the various other components of the illumination device 108.

The mount 124, substrate 136, and heat sink 138 may be made of aluminum or one or more other materials. The light guide 130 and optical elements 128, 132 may be made of one or more materials including transparent and translucent materials (e.g., glass or plastic), reflective and scattering materials (e.g., silver, aluminum, or other metals), and dielectric materials (e.g., organic polymers or inorganic glass). Example processes that may be used to manufacture the various components of the illumination device 108 include extrusion and molding. The various components of the illumination device 108 may be assembled via circuit board assembly techniques and placement machinery processes. In a general embodiment, a divider for defining and illuminating a workspace may include an illumination device that has material compositions different from those of the illumination device 108.

In some cases, a divider for defining and illuminating a workspace may include an illumination device that is asymmetric (e.g., including an asymmetric structure and/or directing light at different angles or in different distributions beyond opposing sides of the frame 102 or directing light beyond only one side of the frame 102). For example, such an illumination device may include a secondary optical element that has only a single redirecting surface and a single output surface, such that the illumination device directs light beyond one side of the divider, as opposed to the symmetric illumination device 108 that directs light beyond both, opposing sides of the divider 100. In some cases, the illumination device 108 may further include a mounting frame and/or brackets (not shown) that can be used to secure the illumination device 108 to the frame 102 within the surface channel 120 of the top edge member 110.

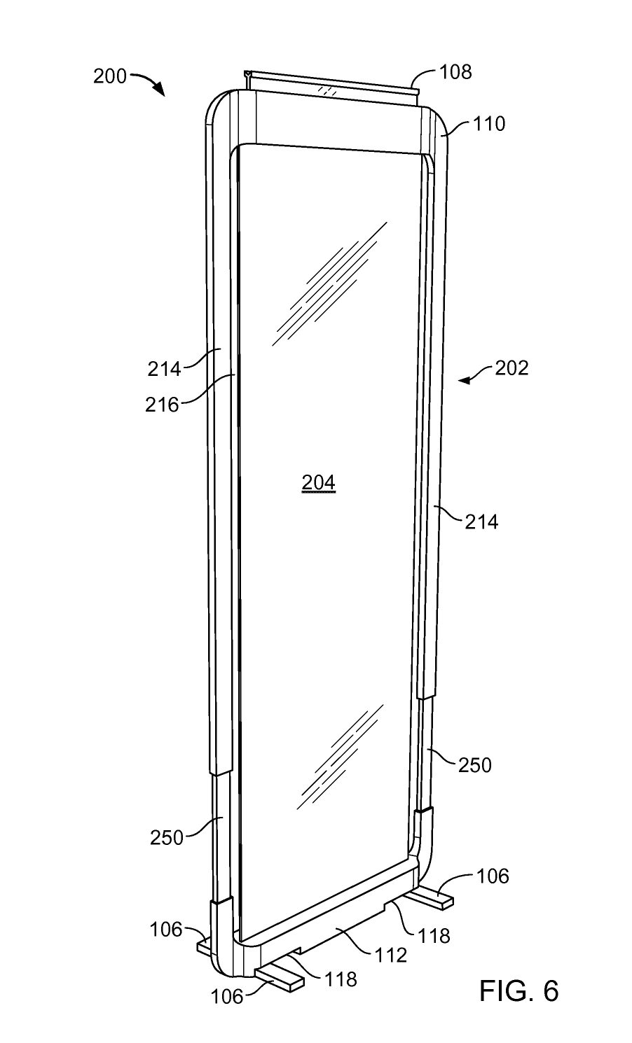

FIG. 6 illustrates a divider 200 (e.g., an adjustable divider) that can be used to define (e.g., bound) and illuminate a workspace within an environment. The divider 200 is similar in construction, material composition, and function to the divider 100 (e.g., a non-adjustable divider), with the exception that the divider 200 includes a frame 202 that is adjustable in height and a screen 204 that is adjustable in deployed length. Accordingly, the divider 200 further includes the four support members 106, the illumination device 108, and the one or more cable harnesses 160 that extend through the frame 202.

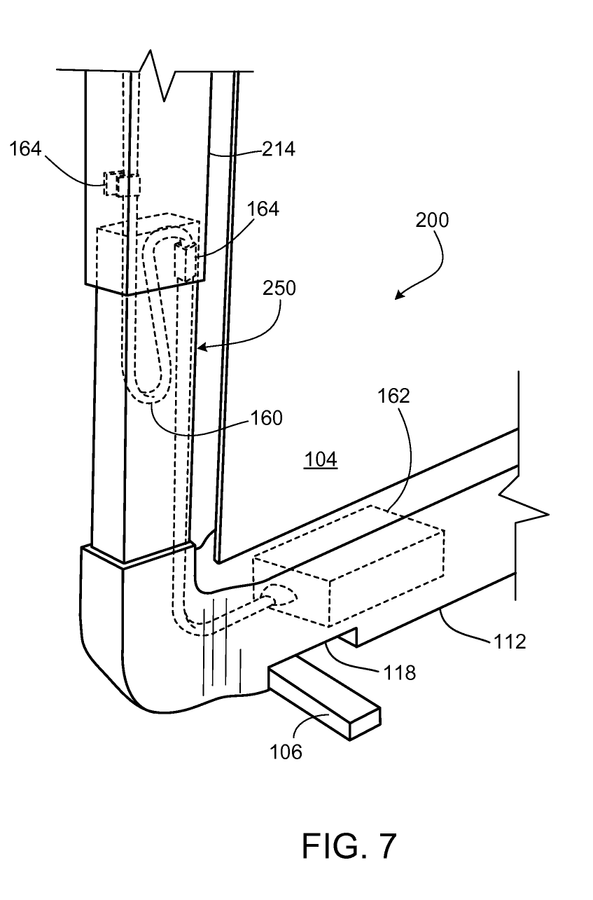

The frame 202 of the divider 200 is formed as a rigid, free-standing frame that includes the top and bottom edge members 110, 112 of the divider 100. The frame 202 further includes two side edge members 214 and two adjustment (e.g., telescopic) members 250 that allow the frame 202 to be adjusted in height. The edge members 110, 112, 214 and the adjustment members 250 together define a central opening 216 (e.g., an expandable opening) through the frame 202. The edge members 214 are substantially similar in construction, material composition, and function to the edge members 114 of the divider 100, with the exception that the edge members 214 include internal features (e.g., stops, detents, recesses, friction and/or other elements not shown) that allow the edge members 214 to slide over and engage the adjustment members 250 at different heights. Accordingly, the adjustment members 250 include complementary features (e.g., detents, stops, recesses, friction and/or other elements not shown) that allow the adjustment members 250 to slide within and engage the side edge members 214. Furthermore, the adjustment members 250 define interior channels through which the cable harnesses 160 can extend for providing power to the illumination device 108, as will be discussed in more detail with respect to FIG. 7. The cable harnesses 160 within the frame 202 receive power (e.g., AC power) from a grounded electrical cable.

The adjustment members 250 of the frame 202 may be made of steel, other metal or plastic or one or more other materials. The adjustment members 250 may be manufactured via roll forming or one or more other manufacturing techniques. The adjustment members 250 may be assembled with the side edge members 214 and the bottom edge member 112 of the frame 202 via slide fitting. The frame 202 has an adjustable height (as measured between the upper edge of the top edge member 110 and the lower edge of the bottom edge member 112) in the range of about 170 cm to about 200 cm. The adjustment members 250 have a length of about 120 cm. In a general embodiment, an adjustable divider for defining and illuminating a workspace may include a frame that has dimensions and/or material compositions different from those of the frame 202. In some cases, a frame of an adjustable divider may include adjustment members that are slidable within an upper portion of a bottom edge member of the divider frame or within both side edge members and the bottom edge member of the divider frame.

FIG. 7 illustrates a lower portion of the divider 200 in a vertically extended configuration with the cable harness 160 extending through the frame 202. The cable harness 160 is plugged into the power supply unit 162 disposed within the bottom edge member 112 and extends upward through the adjustment member 250 and the side edge member 214 to the illumination device 108. The cable harness 160 is coiled within the adjustment member 250 and secured to internal surfaces of the adjustment member 250 and the side edge member 214 via the brackets 164. The cable harness 160 has a length sufficient to allow the cable harness 160 to coil and uncoil within the telescopic member 250 as the frame 202 is lengthened and shortened vertically. In some embodiments, a cable harness 160 may extend alternatively or additionally through the opposing side of the frame 202.

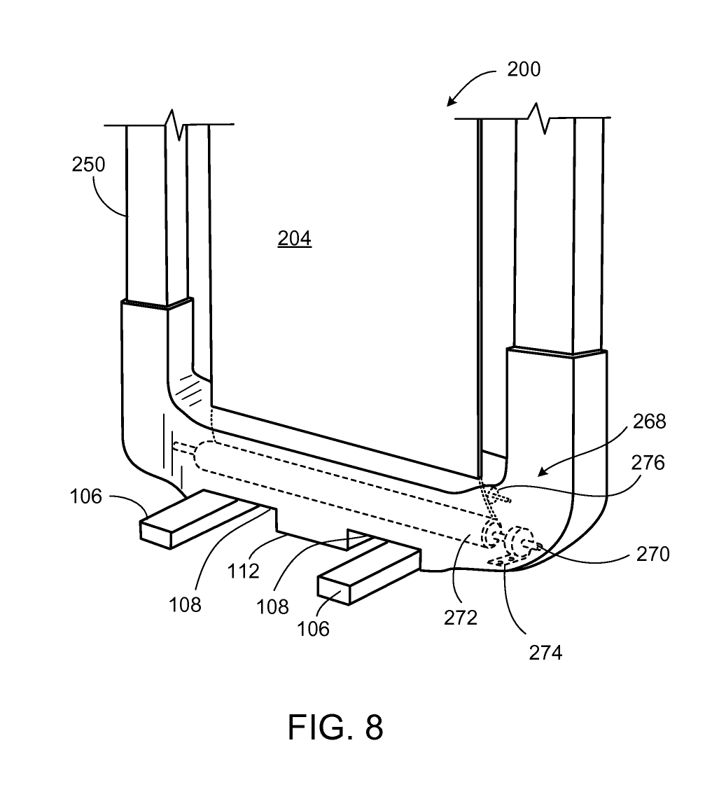

FIG. 8 illustrates the lower portion of the divider 200 in a vertically extended configuration with a spring-loaded mechanism 268 disposed along a lower edge of the screen 204 (cable harness 160 and power supply unit 162 omitted for clarity). The screen 204 of the divider 200 is substantially similar in construction, material composition, and function to the screen 104 of the divider 100, with the exception that the screen 204 may include additional length that allows the screen 204 to adjust (e.g., lengthen or shorten) according to the height of the frame 202. For example, the screen 204, when secured to the top edge member 110 of the frame 202 (as shown in FIG. 6), may be rolled in the spring-loaded mechanism 268 (e.g., under torsional tension) disposed along the bottom edge member 112 of the frame 202 in order to maintain a lengthwise tension on the frame 202 at various heights of the frame 202.

The spring-loaded mechanism 268 includes a spindle 270 around which a roll 272 of screen material is disposed, a coil spring 274 that allows the spindle 270 to rotate, and a rod 276 in contact with the screen 204. The coil spring 274 is attached to the spindle 270 and an internal surface of the bottom edge member 112. Accordingly, the coil spring 274 loosens (e.g., unwinds) as the frame 202 is shortened vertically to allow the screen material to gather in the roll 272 around the spindle 270, and the coil spring 274 tightens (e.g., winds) as the frame 202 is lengthened (e.g., extended) vertically to allow the screen material to unroll around the spindle 270. The rod 276 positions the screen 204 along an opening of the bottom edge member 112. The spring-loaded mechanism 268 may be disposed within an interior region of the bottom edge member 112 and accordingly not visible, as shown in FIG. 8. In other instances, all or a portion of the spring-loaded mechanism 268 may be disposed and visible along a top surface of the bottom edge member 112. In some instances, the screen 204 may be secured to a single edge member (e.g., the top edge member 110) of the frame 202 and rolled up such that the screen 204 spans only a portion (e.g., less than substantially all) of the central opening 216. In some embodiments, the screen 204 may be a stretchable screen made of an elastic material or an elastic weave material. Depending on the embodiment, the stretchable screen may be employed with or without a spring-loaded mechanism. In other embodiments, the screen 204 may be made of a non-elastic material or a non-elastic weave material.

The support members 106 help to prevent the frame 202 from tipping over, as the support members 106 do for the frame 102. For example, the frame 202 may be tilted about 1° to about 5° (e.g., about 3°) with respect to a central plane of the frame 202 (e.g., a plane oriented parallel to the screen 204) without tipping over when the frame 202 is deployed at its maximum height and when the support members 106 are collapsed within the recesses 118 of the bottom edge member 112 (see FIG. 3B for reference). In contrast, the frame 202 may be tilted about 10° to about 14° (e.g., about 12°) with respect to the central plane of the frame 202 without tipping over when the frame 202 is deployed at its maximum height and when the support members 106 are extended from the bottom edge member 112.

The illumination device 108 is positioned and configured to direct light laterally beyond opposite sides of the divider 200 to illuminate a workspace defined by the divider 200, as well as an area surrounding the workspace, as the illumination device 108 does for the divider 100. The divider 200 may further include a mounting frame and/or brackets (not shown) that can be used to secure the illumination device 108 to the frame 202 within the surface channel 120 of the top edge member 110.

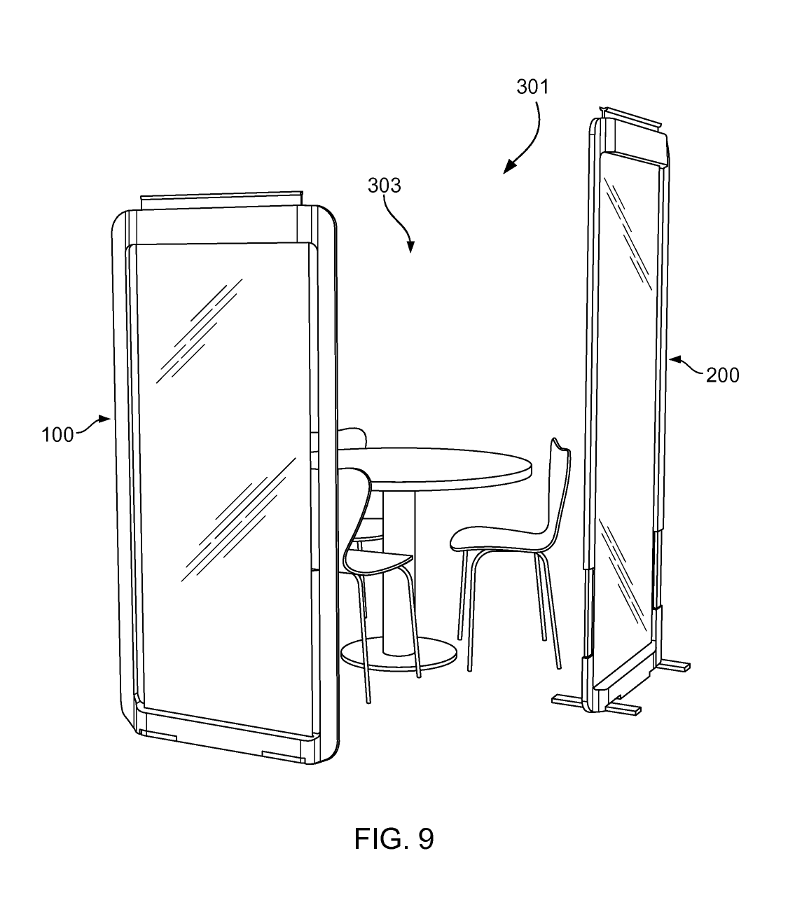

One or more of the dividers 100, 200 may be positioned near or adjacent one another in a variety of arrangements and with the support members 106 collapsed or extended to define and illuminate workspaces of various sizes (e.g., lengths and heights) within an environment. For example, FIG. 9 illustrates a divider system 301 including one divider 100 and one divider 200 positioned near each other for defining (e.g., bounding) and illuminating a workspace 303. The workspace 303 may include one or more tables, chairs, or any other furniture or equipment useful for performing a task within the workspace 303. In some cases, one or more of the dividers 100, 200 may be positioned near a building or room divider (e.g., a stationary or deployable wall) to define and illuminate a workspace within an environment.

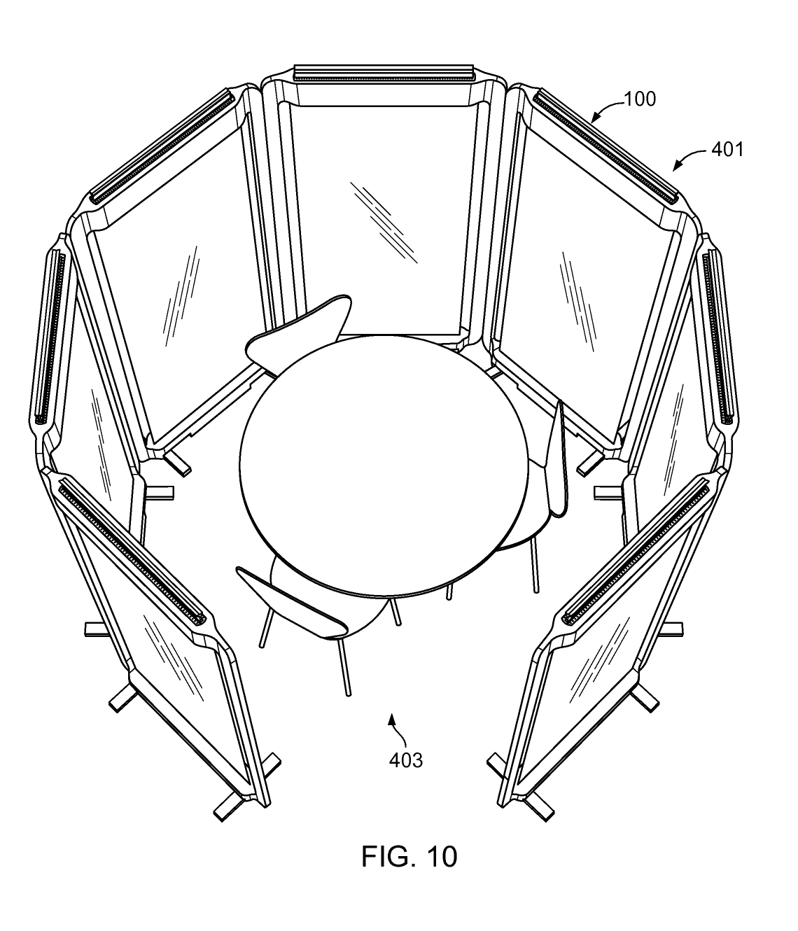

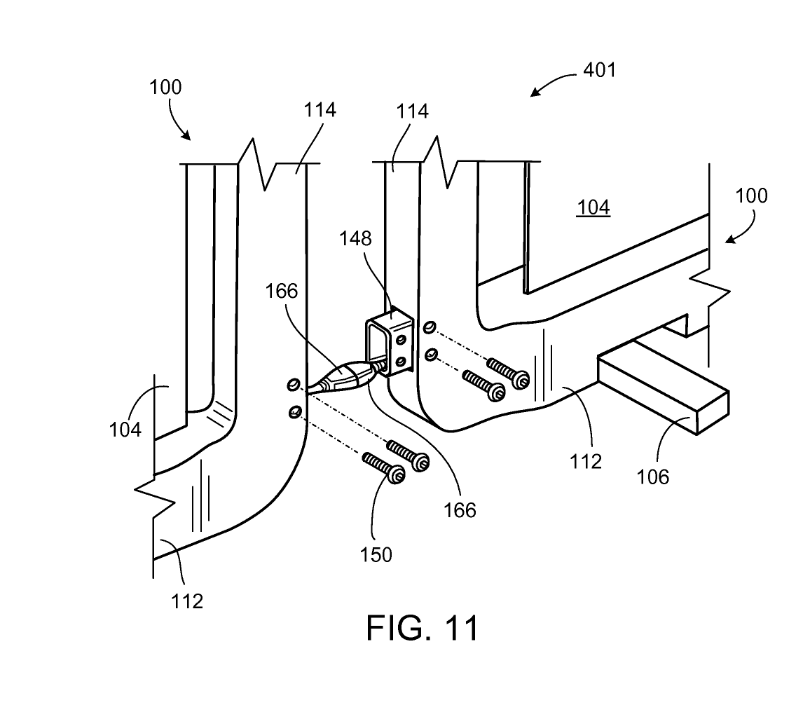

FIG. 10 illustrates a divider system 401 including multiple dividers 100 for defining (e.g., bounding) and illuminating a workspace 403 within an environment. The workspace 403 may include one or more tables, chairs, or other furniture or equipment useful for performing a task within the workspace 403. The divider system 401 further includes mechanical and electrical interconnection systems (shown in FIG. 11) for connecting the dividers 100 of the divider system 401 in a series arrangement. The mechanical interconnection system allows the frames 102 to be mechanically, rigidly connected to one another. The mechanical interconnection system may include brackets (e.g., linear, angled hinging or other brackets), fasteners, hook and loop materials, or magnets that allow adjacent frames 102 to interface with one another in a rigid manner. In some cases, mechanical interconnection of the dividers 100 can provide a self supporting divider system 401, such that the support members 106 of the dividers 100 do not need to be extended (as shown in FIG. 3A) for additional support and balance.

FIG. 11 illustrates a lower portion of the divider system 401 showing interconnection between two adjacent dividers 100 positioned in a linear configuration. The electrical interconnection system includes the cable harnesses 160 extending through the frames 102 and the power supply units 162 (not shown), as well as grounded cables 166 within adjacent frames 102 that connect to each other within and between the adjacent frames 102. The cables 166, when connected, couple the cable harnesses 160 within adjacent frames 102 to one another such that AC power can be delivered to one or more cable harnesses 160 within a single frame 102 and then delivered to adjacent cable harnesses 160 within adjacent frames 102 to power the illumination devices 108 of the dividers 100. End brackets (not shown) may be removed from the bottom edge members 112 of the frames 102 to expose lateral openings within the bottom edge members 112 and allow connection of adjacent grounded cables 166 through the lateral openings. Following connection of the grounded cables 166, an internal bracket 148 of the mechanical interconnection system may be used to mechanically interconnect frames 102 of adjacent dividers 100 using multiple fasteners 150. In some embodiments, the mechanical interconnection system may include angled internal brackets that interconnect two dividers 100 positioned in a non-linear arrangement, as shown in FIG. 10. In some instances, the mechanical interconnection system may include multiple brackets or other interconnection components as described herein that may be positioned at variable locations along the length of the side edge members 114.

In a general embodiment, a divider system including multiple adjacent dividers 100 may include either or both of the mechanical and electrical interconnection systems. Dividers 100 of a divider system without a mechanical interconnection system may be deployed with the support members 106 of the dividers 100 oriented in the extended position so as to provide additional support and balance to the dividers 100.

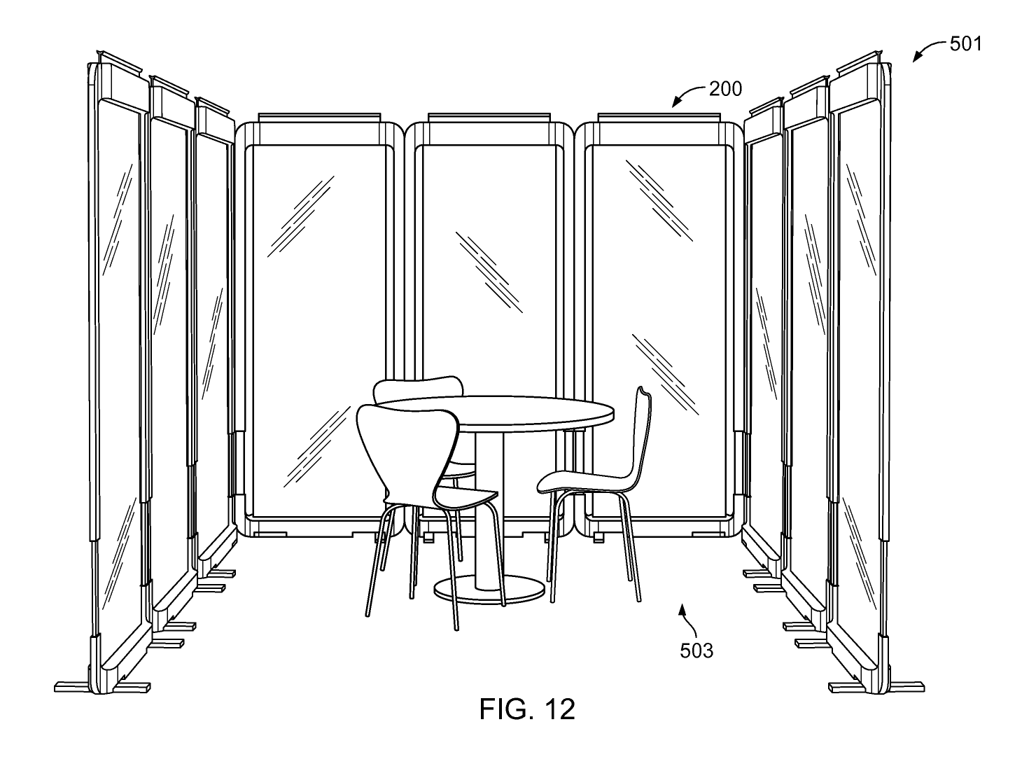

FIG. 12 illustrates a divider system 501 including multiple dividers 200 for defining (e.g., bounding) and illuminating a workspace 503 within an environment. The workspace 503 may include one or more tables, chairs, or any other furniture or equipment useful for performing a task within the workspace 503. The divider system 501 further includes the mechanical and electrical interconnection systems of the divider system 401 (shown in FIG. 11) for connecting the dividers 200 of the divider system 501 in a series arrangement. Accordingly, the mechanical interconnection system allows the frames 202 to be mechanically, rigidly connected to one another and can provide a self supporting divider system 501, such that the support members 106 of the dividers 200 do not need to be extended (as shown in FIG. 3A) for additional support and balance. Furthermore, the cable harnesses 160 within adjacent frames 202 are coupled to one another such that AC power is delivered to one or more cable harnesses 160 within a single frame 202 and then delivered to adjacent cable harnesses 160 within adjacent frames 202 to power the illumination devices 108 of the dividers 200.

In a general embodiment, a divider system including multiple adjacent dividers 200 may include either or both of the mechanical and electrical interconnection systems. For example, the dividers 200 of a divider system without a mechanical interconnection system may be deployed with the support members 106 of the dividers 200 oriented in the extended position so as to provide additional support and balance to the dividers 200.

Any number of the dividers 100, 200 may be interconnected mechanically and/or electrically in one or more linear configurations (e.g., as shown in FIG. 12) or corner configurations (e.g., as shown in FIGS. 10 and 12) to form an interconnected divider system that can define and illuminate workspaces of various sizes (e.g., lengths and heights). In some cases, one or more interconnected divider systems including the dividers 100, 200 may be positioned near one another in a variety of arrangements and with the support members 106 collapsed or extended to define and illuminate a workspace within an environment. In some instances, one or more interconnected divider systems including the dividers 100, 200 may be positioned near a building or room divider (e.g., a stationary or deployable wall) to define and illuminate a workspace within an environment. An interconnected divider system may include both non-adjustable dividers 100 and adjustable dividers 200. In some cases, a divider system may include both interconnected dividers 100, 200 and one or more stand-alone dividers 100, 200. In general, any of the dividers 100, 200 may be used to define and illuminate spaces other than workspaces, such as play areas or storage areas.

A number of examples have been described. Nevertheless, it will be understood that various modifications may be made without departing from the spirit and scope of the claims.

What is claimed is:

1. A workspace divider, comprising:
a divider frame comprising a top edge portion, a bottom edge portion, and two side edge portions connecting the top and bottom edge portions and forming a lateral extent of two opposite broad sides of the divider frame;
a screen secured to the divider frame so as to extend across and essentially span a central opening defined through the divider frame between the top, bottom, and side edge portions; and
an illumination device carried by the top edge portion of the divider frame, the illumination device comprising a light source configured to emit light and disposed along the top edge portion of the divider frame, and a light transmitter extending from the top edge portion of the divider frame and configured to transmit light emitted from the light source and to direct the transmitted light laterally beyond at least one of the broad sides of the divider frame, to illuminate a workspace bounded by the divider frame.

2. The workspace divider of claim 1, wherein the workspace divider is free-standing.

3. The workspace divider of claim 1, wherein the divider frame is adjustable in height.

4. The workspace divider of claim 3, wherein the two side edge portions each comprise an inner edge portion slidably disposed within an outer edge portion, such that the two side edge portions comprise a telescoping joint enabling height adjustment of the divider frame.

5. The workspace divider of claim 4, wherein the screen is adjustable in deployed length.

6. The workspace divider of claim 5, wherein the screen is stretchable.

7. The workspace divider of claim 1, wherein the screen is opaque.

8. The workspace divider of claim 1, wherein the screen is translucent.

9. The workspace divider of claim 1, wherein the screen is secured to the top edge portion of the divider frame.

10. The workspace divider of claim 1, wherein the illumination device is configured to direct light in an angular range towards the workspace and further comprises a primary optical element configured to redirect the light emitted by the light source in a collimated angular range, and wherein the transmitter of the illumination device is provided as a secondary optical element comprising a redirecting surface and an output surface, the redirecting surface arranged and configured to reflect the light received from the primary optical element in the collimated angular range, and the output surface arranged and configured to transmit the light reflected from the redirecting surface towards the workspace.

11. The workspace divider of claim 10, wherein the illumination device further comprises a light guide disposed between the primary optical element and the secondary optical element, the light guide configured to receive the light redirected by the primary optical element at a first end of the light guide and guide at least some of the light to the secondary optical element at a second end of the light guide.

12. The workspace divider of claim 1, wherein the illumination device is configured to direct the transmitted light at different angles or in different distributions beyond the two opposite broad sides of the divider frame.

13. The workspace divider of claim 1, wherein the divider frame further comprises ventilation holes that allow air to cool the illumination device via natural convection.

14. The workspace divider of claim 1, further comprising a plurality of support members disposed along the bottom edge portion of the divider frame.

15. The workspace divider of claim 14, wherein the plurality of support members are attached to the bottom edge portion of the divider frame and are pivotable to extend laterally from the divider frame.

16. The workspace divider of claim 15, wherein the bottom edge portion defines recesses positioned and configured to receive the plurality of support members with the plurality of support members pivoted toward the frame.

17. A workspace divider system comprising, in combination, two or more of the workspace dividers of claim 1, arranged to cooperate to at least partially bound a workspace, with adjacent ones of the workspace dividers positioned with respective side edge portions proximate one another.

18. The workspace divider system of claim 17, further comprising one or more mechanical connection members that rigidly connect the two or more workspace dividers.

19. The workspace divider system of claim 17, further comprising one or more magnetic connection members that resiliently connect the two or more workspace dividers.

20. The workspace divider system of claim 17, further comprising two or more electrical cables that are electrically connectable to each other for mutually powering the illumination devices of the two or more workspace dividers.

21. A workspace divider system, comprising:
a first divider, comprising:
a first divider frame comprising a top edge portion, a bottom edge portion, and two side edge portions connecting the top and bottom edge portions and forming a lateral extent of two opposite broad sides of the first divider frame,
a first screen secured to the first divider frame so as to extend across and essentially span a central opening defined through the first divider frame between the top, bottom, and side edge portions,
a first illumination device carried by the top edge portion of the first divider frame, the first illumination device comprising a light source configured to direct light laterally beyond at least one of the broad sides of the first divider frame, and
a first electrical cable connected to the first illumination device;
a second divider, comprising:
a second divider frame comprising a top edge portion, a bottom edge portion, and two side edge portions connecting the top and bottom edge portions and forming a lateral extent of two opposite broad sides of the second divider frame,
a second screen secured to the second divider frame so as to extend across and essentially span a central opening defined through the divider frame between the top, bottom, and side edge portions,
a second illumination device carried by the top edge portion of the second divider frame, the second illumination device comprising a light source configured to direct light laterally beyond at least one of the broad sides of the second divider frame, and
a second electrical cable connected to the second illumination device;
wherein the first and second dividers comprise an electrical interconnection system by which the first and second electrical cables are electrically connectable to each other for mutual powering of the first and second illumination devices with the first and second dividers placed adjacent one another to bound a workspace.
